(19) United States
(12) Patent Application Publication
(10) Pub. No.: US 2016/0117010 A1
(43) Pub. Date: Apr. 28, 2016

(54) CONDUCTOR PATTERN STRUCTURE OF CAPACITIVE TOUCH PANEL

(71) Applicant: HYCON TECHNOLOGY CORP., Taipei (TW)

(72) Inventors: Hui-Min WANG, Taipei (TW); Yu-Jen WANG, Taipei (TW)

(73) Assignee: HYCON TECHNOLOGY CORP., Taipei (TW)

(21) Appl. No.: 14/523,106

(22) Filed: Oct. 24, 2014

(51) Int. Cl. G06F 3/044

(52) U.S. Cl. CPC G06F 3/044

(57) ABSTRACT

Disclosed is a conductor pattern structure of a capacitive touch panel. The structure contains two conductor assemblies with different directions, and each conductor assembly includes a number of conductive cells that are interconnected by conduction lines. Conductor assemblies with different directions are separated by an insulating material. An electrical field and induced capacitors are generated between adjacent conductor assemblies with different directions when giving control signals. Then the touched location is detected. The capacitive induced layer structure also contains a number of floating induced cells, distributed among the adjacent conductive cells. The floating induced cells generate new induced capacitors without connecting to any conduction lines and requiring any control signals. Therefore, the structure has advantages of improving the distribution of the electrical field and enlarging the touch sensing area.

### FIELD OF THE INVENTION

The present invention relates to a designed structure of a touch panel. More particularly, the present invention relates to a conductor pattern structure of a capacitive touch panel. Touch panels have been applied in large numbers to products of home appliances, communications, electronic information etc., such as wildly commercial Personal Digital Assistant (PDA), every home appliances and gaming input interfaces. With integration of touch panels and displays, it is available for users to use fingers or a stylus to select or input what they want to act according to functional options on a displayed screen of a PDA, a home appliance or a gaming input interface. Thus, it is used as a query tool for public systems so as to provide an operating system which has convenient effects.

### BACKGROUND OF THE INVENTION

The known touch panel is made by forming a sensing area on one surface of the substrate. Touch control is available in the sensing area by sensing human fingers or signals from a stylus. Most materials used in the sensing area are transparent conductive film (e.g. Indium Tin Oxide ITO). It makes users to perform touch control in operation by touching the conductive film where corresponds to a screen on the display.

Currently, commonly applied principles for touch control are resistive type, capacitive induced type, infrared induced type, electromagnetic induced type, sonic induced type, etc. Operation of the capacitive induced type touch panel is to utilize changes of capacitance generated by combination of static electricity arranged between transparent electrodes and human body. Coordinates of the touched location can be detected by the generated induced current. Since the capacitive induced type touch panel has better advantages in the field of transmittance, hardness, accuracy, response time, lifecycle of touch, operating temperature, and initiating force, therefore, it is wildly adopted.

In order to detect the position on the touch panel where the user's finger or stylus is on, manufacturers had developed different kinds of capacitive induced touch sensing technology. For example, a check touch sensitive system is disclosed in the U.S. Pat. No. 6,970,160. Please refer to FIG. 1. It is able to apply to detect a touched location on a touch sensing surface. The check touch sensing system includes two capacitive induced layers. An insulating material is used to separate the two capacitive induced layers to have a capacitive effect. Each capacitive induced layer has conductor assemblies arranged in the same axial direction, and axial directions of the two capacitive induced layers are perpendicular to each other. Each conductor assembly is composed of a number of conductive cells connected by conduction lines. Conductor assemblies on each capacitive induced layer are electrically connected to corresponding conduction lines, then to a control circuit. The control circuit provides signals to two sets of conductor assemblies with different axial directions via the conduction lines, so that an electrical field in the staggered range of the conductive cells in different axial directions is generated. Users touch the staggered range and capacitance values of the induced capacitance will be changed. According to the change of induced capacitance values, users' touched location can be found.

A capacitive touch panel is disclosed in the R.O.C. Patent No. I347545. Only one capacitive induced layer is required in its structure. Conductive elements in two axial directions are placed in the same layer. First axial conductive elements are directly connected by conduction lines while second axial conductive elements cover the insulating layer then being connected by conduction lines. Comparing with the U.S. Pat. No. 6,970,160, a capacitive induced layer is reduced. Hence, the touch panel becomes more compact. Manufacturing processes are simplified.

A capacitive touch panel is disclosed in the R.O.C. Patent No. I430162. Please refer to FIG. 2. The characteristic of the capacitive induced layer is to hollow axial conductive cells so that the axial conductive cells have one or more openings. Covering area and conductivity of the conductive cells are adjusted thereby to improve a touch negative effect that signals interfere one another when multi-touch is applied. The patent also discloses a way to hollow the conductive cells and to increase a shielding induced cell in the hollowed place. It can improve touch negative effect as well. The patent also discloses a way to use conduction lines connecting shielding induced cells to form shielding induced assemblies. The way is to connect the control circuit via conduction lines. The control circuit provides signals to the conductor assembly or shielding induced assembly via the conduction lines. It has an effect to improve distribution of an electrical field and increase sensitivity. However, the defect is to increase the number of conduction lines and complexity of the control circuit.

In the U.S. Pat. No. 6,970,160 and R.O.C. Patent No. I347545, although both patents indicate the function to sense users' touch on the touch panel, there are limitations of uneven distribution of the electrical field and sensing area due to the conductive cells in both prior arts. No matter the shape of the conductive cells in the prior arts is square, hexagonal or others, the sensing area is located in the brinks of the conductive cells. If the users only touch the center portion of the conductive cell, the conductive cell can not process to sense. Therefore, area of the conductive cell must be smaller than that of a user's finger touched. Otherwise, there would be some area where it is not able to process to sense.

Please refer to FIG. 3. In the R.O.C. Patent No. I430162, a way to hollow the center of conductive cells and a way to increase shielded sensing cells in the hollowed conductive cells are disclosed. Although the defect of touch negative effect is improved, it is workable in the brinks of the conductive cells. In addition, a method for providing signals to the shielding induced assembly is also disclosed in this patent. Although it has the effect to improve distribution of an electrical field and increase sensitivity, the defect is to increase the number of conduction lines and complexity of the control circuit, causing serious signal interference among the conduction lines. It is difficult to implement since there are too many conduction lines if the method is applied to a large control panel.

Hence, induced layers of control panels need to improve the technique of distribution of electrical field without increasing conduction lines. Not only the sensing area of conductive cells is enlarged in case there are areas on the touch panel, but no extra conduction line is required.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

A main goal of the present invention is to provide a capacitive touch panel causing an even electrical field. When it is applied to a double-layered induced structure, the structure includes two capacitive induced layers. An insulating material is provided between the two capacitive induced layers to separate them so that capacitive effect is formed. Each capacitive induced layer includes conductor assemblies arranged in the same axial direction. Axial directions of the two capacitive induced layers are perpendicular to each other. Each conductor assembly is composed of a number of conductive cells connected by a conduction line. The capacitive induced layer of the present invention further comprises a number of floating induced cells. Each floating induced cell is distributed between adjacent first axial conductive cells or between adjacent second axial conductive cells. A proper distance is kept between those floating induced cells and first axial conductive cells or adjacent second axial conductive cells. Conduction lines are not required, neither are the signals to be provided. New induced capacitors can be generated to evenly distribute the electrical field and enlarge the sensing area.

When the present invention is applied to a single-layered induced structure, the structure includes two axial conductor assemblies. Each conductor assembly is composed of a number of conductive cells connected by a conduction line. An insulating layer is used to separate conduction lines in different axial directions. The capacitive induced layer in the present invention further includes a number of floating induced cells. Each floating induced cell is distributed between each adjacent first axial conductive cell and second axial conductive cell. A proper distance is kept between those floating induced cells and first axial conductive cells or adjacent second axial conductive cells. Conduction lines are not required, neither are the signals to be provided. New induced capacitors can be generated to evenly distribute the electrical field and enlarge the sensing area.

The sensing principle used in the prior arts is to generate a basic induced capacitors by generating an electrical field in an adjacent area of conductive cells in two different axial directions. When the user's finger touch the sensing area of the electrical field, capacitance values of the basic induced capacitors will change, further calculating the user's touched location based on the change of capacitance values.

After the floating induced cells are added according to the present invention, two axial conductive cells will generate an electrical field with the floating induced cell in adjacent area, respectively. Each will have an equivalent capacitance value. These two capacitors are called floating induced capacitor. The two floating induced capacitors are connected in series between two different axial conductive cells. Reciprocal of the equivalent capacitance value equals to the sum of reciprocals of the two floating induced capacitance values. The floating induced capacitors are distributed around the floating induced cells to increase the sensing range.

The present invention modifies the shape of the conductive cells, and puts the floating induced cells in gaps between the conductive cells. It is to increase the range of touch sensing area so that the electrical field is distributed more evenly. It can also prevent the conductive cells from the situation that the central area can not process to sense. The technology of floating induced cell can be applied to both single-layered induced structure and double-layered induced structure.

According to the present invention, the capacitive touch panel according to the present invention has a conductor pattern structure formed on a surface of a substrate, including: a number of first axial conductor assemblies, each first axial conductor assembly comprising a number of first axial conductive cells formed on the surface of the substrate along a first axial direction; a number of second axial conductor assemblies, each second axial conductor assembly comprising a number of second axial conductive cells formed on the surface of the substrate along a second axial direction; a number of first axial conduction lines, each connecting every adjacent first axial conductive cells in one first axial conductor assembly, respectively; a number of insulators, each formed between adjacent second axial conductive cells in one second axial conductor assembly, respectively; a number of second axial conduction lines, each crossing surfaces of corresponding insulators and connecting every adjacent second axial conductive cells in one second axial conductor assembly, respectively; and a number of floating induced cells, each formed between one first axial conductive cell and one second axial conductive cell, respectively.

Preferably, the aforementioned capacitive touch panel further includes a number of insulators, each formed between adjacent first axial conductive cells in one first axial conductor assembly, respectively, so that each first axial conduction line crosses surfaces of corresponding insulators and connects every adjacent first axial conductive cells in one first axial conductor assembly, respectively.

Preferably, the present invention can be applied to another conductor pattern structure of induced capacitive touch panel, including: a number of first axial conductor assemblies, each first axial conductor assembly comprising a number of first axial conductive cells connected by a first axial conduction lines and formed on the surface of the substrate along a first axial direction; a number of second axial conductor assemblies, each second axial conductor assembly comprising a number of second axial conductive cells and formed on the surface of the substrate along a second axial direction; a number of second axial conduction lines, each linked the second axial conductive cells to a brink of the surface of the substrate, respectively; and a number of floating induced cells, each formed between one first axial conductive cell and one second axial conductive cell, respectively.

Preferably, the conductor pattern structure further includes a number of connecting lines, connecting second axial conduction lines belonging to the same conductor assembly so that the second axial conductive cells belonging to the same conductor assembly connected to one another.

Preferably, the present invention can also be applied to a double-layered induced capacitive touch panel. The conductor pattern structure includes: a first induced layer, comprising a number of first axial conductor assemblies arranged according to a first axial direction, each first axial conductor assembly is composed of a number of first axial conductive cells connected by conduction lines; a second induced layer, comprising a number of second axial conductor assemblies arranged according to a second axial direction, each second axial conductor assembly is composed of a number of second axial conductive cells connected by conduction lines; an insulating layer, formed by arranging an insulating material between the first induced layer and the second induced layer to form a capacitive effect; and a number of floating induced cell, each floating induced cell formed between one first induced layer one first axial conductor assemblies, or between second axial conductor assemblies of the second induced layer.

For the conductor pattern structure of induced capacitive touch panel mentioned above, the first axial conductive cell, the second axial conductive cell, and the floating induced cell has a shape of square, hexagonal, elongated, or cruciform, or a combination thereof.

The conductor pattern structure of induced capacitive touch panel mentioned above further includes a number of signal transmission lines formed on the surface of the substrate. Each signal transmission lines connecting every first axial conductor assemblies and every second axial conductor assemblies respectively.

For the conductor pattern structure of induced capacitive touch panel mentioned above, a direction of distribution of the first axial conductor assembly is orthogonal to that of the second axial conductor assembly.

For the conductor pattern structure of induced capacitive touch panel mentioned above, every first axial conductive cells, second axial conductive cells, first axial conduction lines and second axial conduction lines are made of a transparent conductive material. The transparent conductive material may be Indium Tin Oxide (ITO).

### BRIEF DESCRIPTION OF THE DRAWINGS

FIG. 1 illustrates a conventional conductor pattern structure of a double-layered capacitive touch panel.

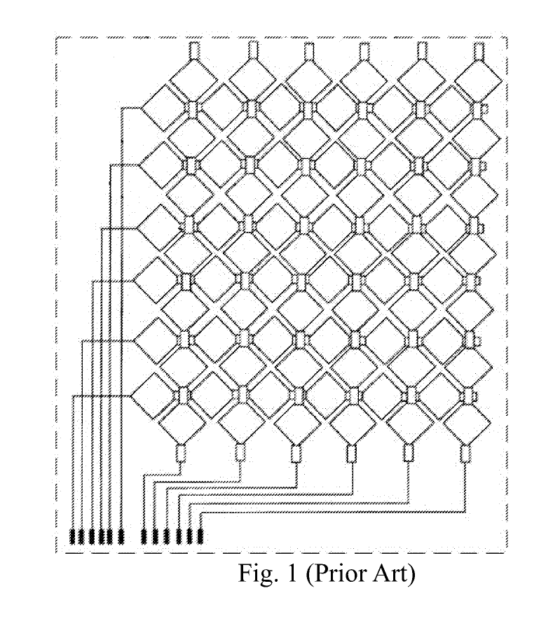

FIG. 2 illustrates a conventional conductor pattern structure of a single-layered capacitive touch panel.

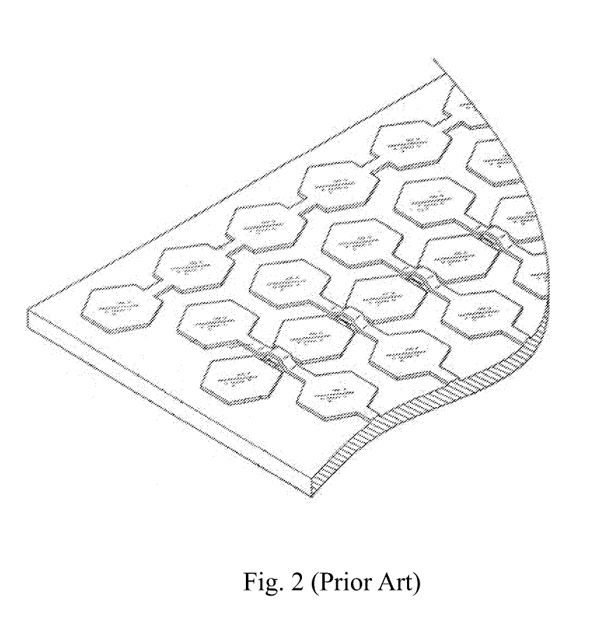

FIG. 3 shows a conventional conductor pattern structure of capacitive touch panel where the pattern structure includes shielding induced cells.

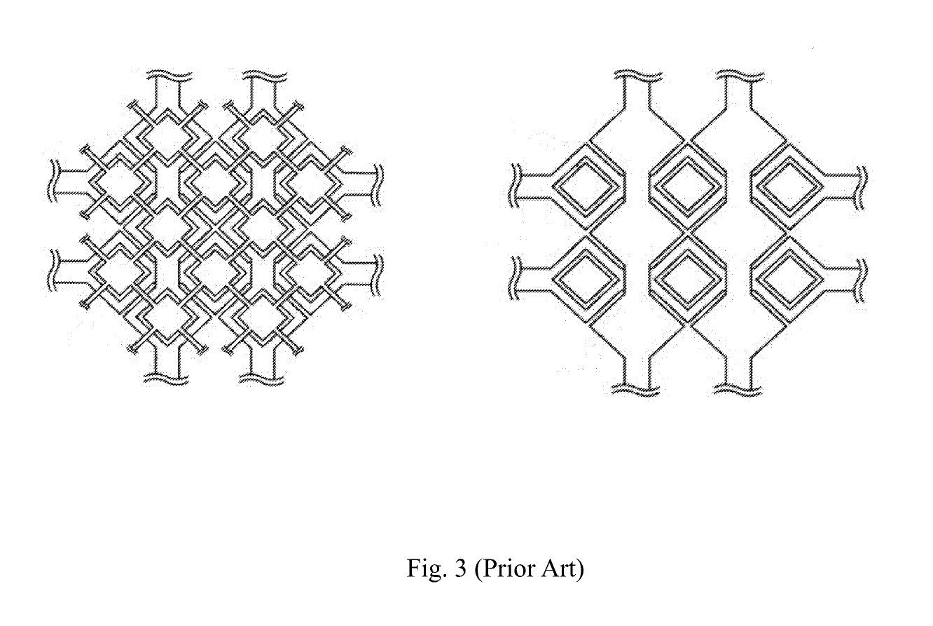

FIG. 4 illustrates the conductor pattern structure of the single-layered capacitive touch panel in the embodiments in the present invention.

FIG. 5 illustrates a partially enlarged view of two axial conductive cells and floating induced cells in the embodiments in the present invention.

FIG. 6 illustrates a conductor pattern structure of another single-layered capacitive touch panel in the embodiments in the present invention.

FIG. 7 illustrates the conductor pattern structure of the double-layered capacitive touch panel in the embodiments in the present invention.

### DETAILED DESCRIPTION OF THE PREFERRED EMBODIMENT

The present invention will now be described more specifically with reference to the following embodiments. It should be noticed that the embodiment of the present invention described below is only for the purpose of description. It is not intent that the present invention has been described in details or limited by the form of disclosure.

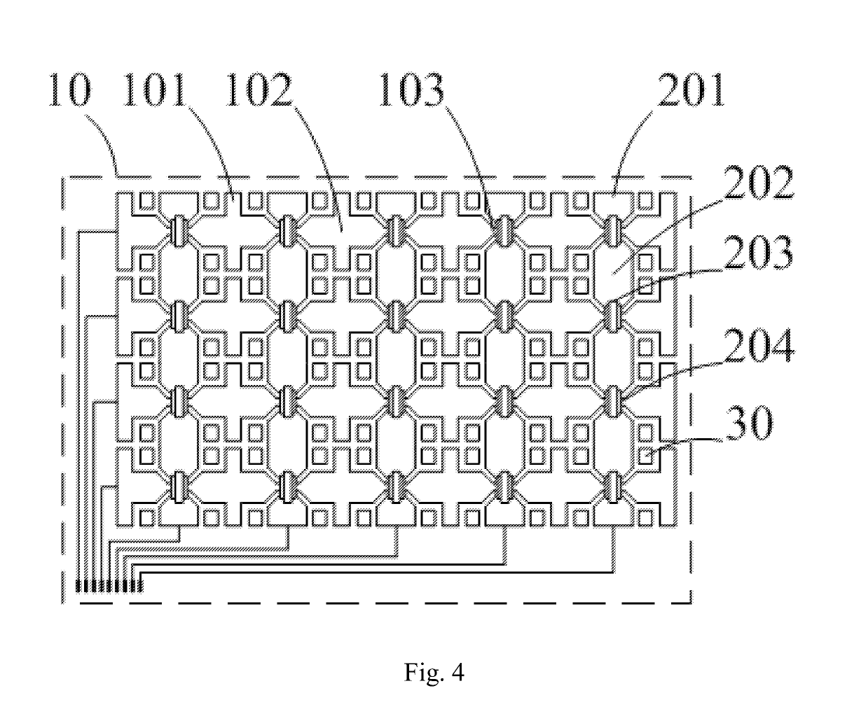

Please refer to FIG. 4. A first embodiment of the present invention is illustrated. It shows a conductor pattern structure of a single-layered induced capacitive touch panel. A capacitive induced layer 10 includes 4 transverse first axial conductor assemblies 101, 5 longitudinal second axial conductor assemblies 201 and 80 floating induced cells 30. Each first axial conductor assembly 101 includes 6 first axial conductive cells 102. Adjacent first axial conductive cells 102 are connected directly by a conduction line 103. Each second axial conductor assembly 201 includes 5 second axial conductive cells 202. Adjacent second axial conductive cells 202 is covered by an insulating material then connected by a conduction line 203 on the surface of the insulating layer 204. Each floating induced cell 30 is placed in a gap between one first axial conductive cell 102 and a second axial conductive cell 202.

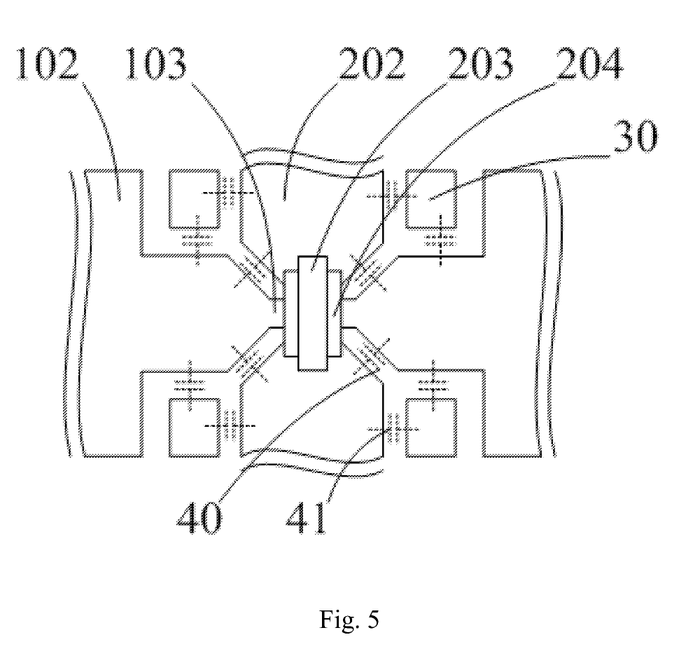

FIG. 5 illustrates a partially enlarged view of two axial conductive cells and floating induced cells in the embodiment in the present invention. The first axial conductive cell 102 has a cruciform shape. The second axial conductive cell 202 has an elongated shape. An area of one axial conductive cell where neighbors other axial conductive cells is adjusted as a bevel edge. The floating induced cell 30 has a shape of square, placed in a gap between one first axial conductive cell 102 and one second axial conductive cell 202.

FIG. 5 also illustrates the induced capacitor generated by two axial conductive cells and a floating induced cell 30. When a control signal is provided to the two axial conductor assemblies, a basic induced capacitor 40 will be generated in the adjacent area of the two axial conductive cells. Floating induced capacitors 41 will be formed in the adjacent areas of the floating induced cell 30 and two axial conductive cells.

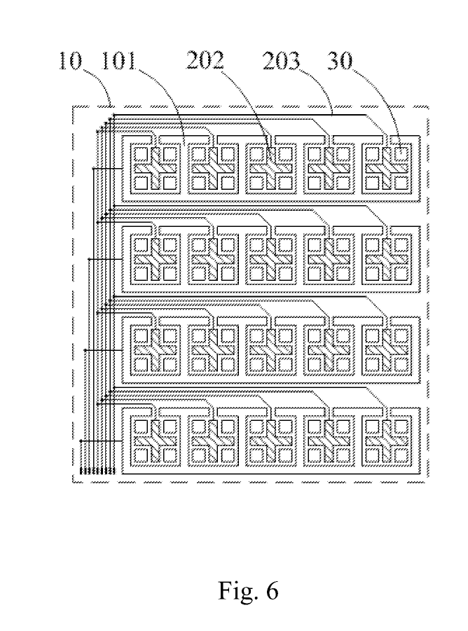

Please refer to FIG. 6. A second embodiment of the present invention is illustrated. It shows a conductor pattern structure of a single-layered induced capacitive touch panel. The capacitive induced layer 10 includes 4 transverse first axial conductor assemblies 101, 5 longitudinal second axial conductor assemblies 201 and 80 floating induced cells 30. Each first axial conductor assembly 101 includes 5 connected first axial conductive cells 102. Each second axial conductor assembly 201 includes 4 second axial conductive cells 202. Each floating induced cell 30 is placed in the gap between one first axial conductive cell 102 and one second axial conductive cells 202.

In this embodiment, the way to connect conductive cells is different from that of the first embodiment. The first axial conductor assemblies 101 in this embodiment have box-shaped first axial conductive cells 102 which are directly connected. The cruciform second axial conductive cells 202 in the second axial conductor assemblies 201 are linked to a brink of the induced layer via conduction lines 203, and then covered by an insulating layer 204 for cross-wire connection. The advantages of the connection are that it needs no insulating material in the center of the induced layer, manufacturing processes are simplified and the induced layer will have better transmittance when applying to electronic products such as a touch screen. The connection is done in the area out of user's screen so that a general material which is not transparent can be chosen for the insulator.

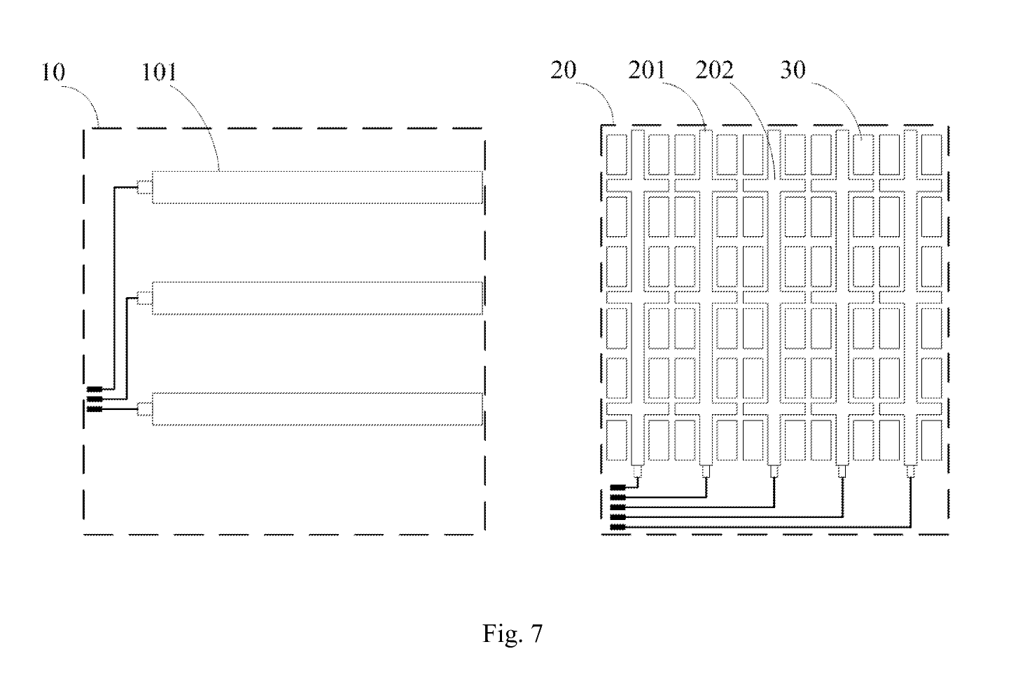

Please refer to FIG. 7. A third embodiment of the present invention is illustrated. It shows a conductor pattern structure of a double-layered induced capacitive touch panel. A first induced layer 10 includes 3 transverse first axial conductor assemblies 101. Each first axial conductor assembly 101 includes 5 first axial conductive cells 102 connected by a conduction line 103 and then formed as an elongated shape. The second induced layer 20 includes 5 second axial conductor assemblies 201 arranged according to a second axial direction. Each second axial conductor assembly 201 includes 3 second axial conductive cells 202 connected by a conduction line 203. The second axial conductive cells 202 have a cruciform shape. An insulation layer is formed by an insulating material and between the first induced layer 10 and the second induced layer 20. Therefore, a capacitive effect is formed. The second induced layer 20 further includes 60 floating induced cells 30. Each floating induced cell 30 between second axial conductor assemblies 201 of the second induced layer 20.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A capacitive touch panel, having a conductor pattern structure formed on a surface of a substrate, comprising:
a plurality of first axial conductor assemblies, each first axial conductor assembly comprising a plurality of first axial conductive cells formed on the surface of the substrate along a first axial direction;
a plurality of second axial conductor assemblies, each second axial conductor assembly comprising a plurality of second axial conductive cells formed on the surface of the substrate along a second axial direction;
a plurality of first axial conduction lines, each connecting every adjacent first axial conductive cells in one first axial conductor assembly, respectively;
a plurality of insulators, each formed between adjacent second axial conductive cells in one second axial conductor assembly, respectively;
a plurality of second axial conduction lines, each crossing surfaces of corresponding insulators and connecting every adjacent second axial conductive cells in one second axial conductor assembly, respectively; and
a plurality of floating induced cells, each formed between one first axial conductive cell and one second axial conductive cell, respectively.

2. The capacitive touch panel according to claim 1, further comprising a plurality of insulators, each formed between adjacent first axial conductive cells in one first axial conductor assembly, respectively, so that each first axial conduction line crosses surfaces of corresponding insulators and connects every adjacent first axial conductive cells in one first axial conductor assembly, respectively.

3. The capacitive touch panel according to claim 1, wherein the first axial conductive cell, the second axial conductive cell, and the floating induced cell has a shape of square, hexagonal, elongated, or cruciform, or a combination thereof.

4. The capacitive touch panel according to claim 1, further comprising a plurality of signal transmission lines, formed on the surface of the substrate, each signal transmission lines connecting every first axial conductor assemblies and every second axial conductor assemblies respectively.

5. The capacitive touch panel according to claim 1, wherein a direction of distribution of the first axial conductor assembly is orthogonal to that of the second axial conductor assembly.

6. The capacitive touch panel according to claim 1, wherein every first axial conductive cells, second axial conductive cells, first axial conduction lines and second axial conduction lines are made of a transparent conductive material.

7. The capacitive touch panel according to claim 6, wherein the transparent conductive material is Indium Tin Oxide (ITO).

8. A capacitive touch panel, having a conductor pattern structure formed on a surface of a substrate, comprising:
a plurality of first axial conductor assemblies, each first axial conductor assembly comprising a plurality of first axial conductive cells connected by a first axial conduction lines and formed on the surface of the substrate along a first axial direction;
a plurality of second axial conductor assemblies, each second axial conductor assembly comprising a plurality of second axial conductive cells and formed on the surface of the substrate along a second axial direction;
a plurality of second axial conduction lines, each linked the second axial conductive cells to a brink of the surface of the substrate, respectively; and
a plurality of floating induced cell, each formed between one first axial conductive cell and one second axial conductive cell, respectively.

9. The capacitive touch panel according to claim 8, further comprising a plurality of connecting lines, connecting second axial conduction lines belonging to the same conductor assembly so that the second axial conductive cells belonging to the same conductor assembly connected to one another.

10. The capacitive touch panel according to claim 8, wherein the first axial conductive cell, the second axial conductive cell, and the floating induced cell has a shape of square, hexagonal, elongated, or cruciform, or a combination thereof.

11. The capacitive touch panel according to claim 8, further comprising a plurality of signal transmission lines, formed on the surface of the substrate, each signal transmission lines connecting every first axial conductor assemblies and every second axial conductor assemblies respectively.

12. The capacitive touch panel according to claim 8, wherein a direction of distribution of the first axial conductor assembly is orthogonal to that of the second axial conductor assembly.

13. The capacitive touch panel according to claim 8, wherein every first axial conductive cells, second axial conductive cells, first axial conduction lines and second axial conduction lines are made of a transparent conductive material.

14. The capacitive touch panel according to claim 13, wherein the transparent conductive material is Indium Tin Oxide (ITO).

15. A capacitive touch panel, having a double-layered conductor pattern structure formed on a surface of a substrate, comprising:
a first induced layer, comprising a plurality of first axial conductor assemblies arranged according to a first axial direction, each first axial conductor assembly is composed of a plurality of first axial conductive cells connected by conduction lines;
a second induced layer, comprising a plurality of second axial conductor assemblies arranged according to a second axial direction, each second axial conductor assembly is composed of a plurality of second axial conductive cells connected by conduction lines;
an insulating layer, formed by arranging an insulating material between the first induced layer and the second induced layer; and
a plurality of floating induced cells, each floating induced cell formed between one first induced layer one first axial conductor assemblies, or between second axial conductor assemblies of the second induced layer.

16. The capacitive touch panel according to claim 15, wherein the first axial conductive cell, the second axial conductive cell, and the floating induced cell has a shape of square, hexagonal, elongated, or cruciform, or a combination thereof.

17. The capacitive touch panel according to claim 15, further comprising a plurality of signal transmission lines, formed on the surface of the substrate, each signal transmission lines connecting every first axial conductor assemblies and every second axial conductor assemblies respectively.

18. The capacitive touch panel according to claim 15, wherein a direction of distribution of the first axial conductor assembly is orthogonal to that of the second axial conductor assembly.

19. The capacitive touch panel according to claim 15, wherein every first axial conductive cells, second axial conductive cells, first axial conduction lines and second axial conduction lines are made of a transparent conductive material.

20. The capacitive touch panel according to claim 19, wherein the transparent conductive material is Indium Tin Oxide (ITO).
